(19) United States
(12) Patent Application Publication
(10) Pub. No.: US 2011/0308993 A1
(43) Pub. Date: Dec. 22, 2011

(54) COLLAPSIBLE BULK BIN CONTAINER

(75) Inventors: John Benjamin Hill, Chicago, IL (US); David Fred Kari, Bloomingdale, IL (US)

(73) Assignee: INTERNATIONAL PAPER COMPANY, Memphis, TN (US)

(21) Appl. No.: 13/111,552

(22) Filed: May 19, 2011

Related U.S. Application Data
(60) Provisional application No. 61/346,123, filed on May 19, 2010.

(51) Int. Cl. B65D 19/20; B31B 1/26; B31B 1/90; B31B 1/06; B65D 19/38; B65D 5/36

(52) U.S. Cl. 206/600; 220/6; 220/8; 229/117.01; 493/84; 493/102; 493/122; 493/162

(57) ABSTRACT

A collapsible shipping container is capable of configured from a collapsed position for storage and transportation to a constructed position for containment of articles therein and back again to the collapsed position after use. The collapsible shipping container comprises a foldable tray having at least two pallet runner sleeves spaced apart from one another and each of which being formed on respective opposed lateral edges of the foldable tray. A plurality of elongated pallet runners each of which having an inner support structure integrally formed thereto. The plurality of elongated pallet runners each of which is adapted to be inserted into each of the respective plurality of pallet runner sleeves. A foldable side wall body is adapted to rest upon the foldable tray to form an interior space to receive a plurality of articles. The foldable side wall body comprises end walls, side walls, and side body flaps to form an enclosed bottom thereof. Each of the end walls includes an articulation fold formed therein so that during the collapsed position, the articulation folds move toward the interior space and during the constructed position, the articulation folds move away from the interior space. A lid is configured to telescopically enclosing the collapsible shipping container.

### CROSS REFERENCE TO RELATED APPLICATIONS

This application claims priority to U.S. provisional patent application Ser. No. 61/346,123, filed on 19 May 2010, which is hereby incorporated hereinto by reference as if fully restated herein.

### FIELD OF THE INVENTION

This invention relates to shipping containers, and more particularly to corrugated paperboard containers that may be shipped in a collapsed or knocked-down state and easily assembled into a larger container for use and being disassembled for re-use.

### BACKGROUND OF THE INVENTION

Corrugated paperboard containers are commonly used to store and transport a variety of goods. Many of these containers are quite large, holding from 500 to 2,000 pounds or more of product, and typically are placed on pallets so that the containers may be handled with forklifts or jack trucks and the like. Wooden pallets are used in most conventional systems. These pallets are strong but they also are relatively heavy and expensive and are difficult to transport or recycle after use. Moreover, containers that are stacked upon but not fastened to the pallet may become displaced during handling, thereby causing the forklift operator to waste valuable time in rearranging the containers on the pallet. In extreme cases, the containers may actually fall off the pallet, causing damage to or destruction of the goods being transported.

To avoid these problems, integrated container and pallet constructions have been developed in the prior art. In these constructions the bottom of the container is configured to have a pallet integrated into it, with outboard runners of the pallet extending along the outer side edges of the container, and openings inboard of the outboard runners for receiving the tines of a forklift. Conventional containers of this type usually are dimensioned to fit on a standard 40 inch by 48 inch pallet, and the tines of a forklift normally are set so that they extend through the openings inboard of the outermost runners. One problem with such containers is the ability to ship the containers in an unassembled or knock-down flattened condition, to reduce initial shipping costs due to its size, while providing the ability to set up such containers at the customer destination or other end user. Another problem is to store, destroy or otherwise handle wooden pallets.

Therefore, it would be desirable to have a collapsible bulk bin container that can be shipped in a knocked-down flattened condition or collapsed condition and as a single contained unit. Further, it would be desirable to have such a container that can be easily and quickly set up at the user's facility and that could be knocked down or disassembled upon completion of the use.

### SUMMARY OF THE INVENTION

Some of the advantages of the collapsible bulk bin container of the present invention are as follows: the collapsible bulk bin container is a complete bulk bin kit including a bulk bin, a corrugated pallet and an integrated lid. There is no need for additional lid components or wooden pallets. The collapsible or knock-down flattened condition bulk bin folds from the knock down position to the open position easily and quickly. The knock-down bulk bin is completely recyclable (when comprised of the standard corrugated components). The collapsible or knock-down bulk bin can be stacked and stored efficiently in a warehouse when in the knocked down configuration. The knock-down position can also provide convenient and efficient returnable packaging for customers. The knock-down bulk bin can include various “kit” items i.e.: bags, corner boards, partitions, pads etc. depending on a customer's needs. The knock down pallet can also be shipped internationally without having to meet lumber treatment codes as there is no wood in the design.

Accordingly, one aspect of the present invention is directed to a collapsible container comprising a foldable tray having a plurality of pallet runner sleeves. A plurality of elongated pallet runners each of which is adapted to be removably inserted into each of the respective plurality of pallet runner sleeves. A foldable side wall body is adapted to rest upon the foldable tray to form an interior space to receive a plurality of articles. A lid is telescopically enclosing the collapsible container. The foldable tray comprises a plurality of fork access openings formed therein to accommodate the tines of a forklift. The plurality of fork access openings are in both opposed side walls of the foldable tray for a two-way entry of the tines of a forklift. The plurality of pallet runner sleeves includes two pallet runner sleeves spaced apart from one another and are integrally formed on respective opposed lateral edges of the foldable tray. Each of the plurality of elongated pallet runners includes an inner support structure integrally formed thereto to enhance lateral strength of each of the plurality of elongated pallet runners. The plurality of elongated pallet runners includes three pallet runners wherein two of which are inserted to the respective plurality of pallet runner sleeves and one of the three pallet runners is disposed in proximity of center of the foldable tray. Both opposed ends of each of the plurality of elongated pallet runners are enclosed. The foldable side wall body comprises end walls, side walls, and side body flaps to form an enclosed bottom thereof and wherein each of the end walls includes an articulation fold formed therein to bisect the respective end wall panels. The foldable side wall body is attached to the foldable tray via an attachment flap. The foldable sidewall body sits inside peripheral boundaries of the foldable tray having a minimum profile. The foldable tray, the plurality of elongated pallet runners, and the foldable side wall body are all formed from corrugated paperboard material.

Another aspect of the present invention is directed to a collapsible shipping container is capable of configured from a collapsed position for storage and transportation to a constructed position for containment of articles therein and back again to the collapsed position after use. The collapsible shipping container comprises a foldable tray having at least two pallet runner sleeves spaced apart from one another and each of which being formed on respective opposed lateral edges of the foldable tray. A plurality of elongated pallet runners each of which having an inner support structure integrally formed thereto. The plurality of elongated pallet runners each of which is adapted to be inserted into each of the respective plurality of pallet runner sleeves. A foldable side wall body is adapted to rest upon the foldable tray to form an interior space to receive a plurality of articles. The foldable side wall body comprises end walls, side walls, and side body flaps to form an enclosed bottom thereof. Each of the end walls includes an articulation fold formed therein so that during the collapsed position, the articulation folds move toward the interior space and during the constructed position, the articulation folds move away from the interior space. A lid is configured to telescopically enclosing the collapsible shipping container.

One further aspect of the present invention is directed to a method for constructing a collapsible shipping container. The method comprising the steps of forming a foldable tray made from a blank B4. The foldable tray has a base wall panel, two side wall panels, and two end wall panels which are formed by two pairs of respective fold lines intersecting one another at right angles. Two pallet runner sleeves are formed between the base wall panel and the two opposed end wall panels. Then, forming a plurality of elongated pallet runners each of which made from a blank B1, the plurality of elongated pallet runners being affixed to the foldable tray, the plurality of elongated pallet runners includes an inner support structure integrally formed thereto and forming a foldable side wall body made from a blank B3, the foldable side wall body configured to be attached to the foldable tray to form an interior space to receive a plurality of articles wherein the foldable side wall body comprises two end walls, two side walls, and side body flaps to form an enclosed bottom thereof wherein each of the end walls includes an articulation fold formed therein so that during the collapsed position, the articulation folds move toward the interior space and during the constructed position, the articulation folds move away from the interior space.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is an exploded perspective view of collapsible bulk bin container in the collapsed configuration in accordance to a preferred embodiment of the present invention;

FIG. 2 is a top plan view of a blank B1 for making a pallet runner for use in the collapsible bulk bin container in accordance to a preferred embodiment of the present invention;

FIGS. 3A-3E illustrates the folding sequences of the blank B1 shown in FIG. 1 for constructing the pallet runner in accordance to the present invention;

FIG. 4 is a top perspective view of the constructed pallet runner for use in the collapsible bulk bin container;

FIG. 5 is a cross sectional view of the pallet runner taken along line 5-5 of FIG. 4;

FIG. 6 is a top plan view of a blank B2 for making the lid for the collapsible bulk bin container in accordance to a preferred embodiment of the present invention;

FIGS. 7A-7B illustrates the folding sequences of the blank B2 shown in FIG. 6 for constructing the lid in accordance to the present invention;

FIG. 8 is a top perspective view of the constructed lid for use in the collapsible bulk bin container;

FIG. 9 is a top plan view of a blank B3 for making a foldable sidewall body blank for use in the collapsible bulk bin container;

FIGS. 10A-10E illustrates the folding sequences of the blank B3 shown in FIG. 9 for constructing the foldable sidewall body in accordance to the present invention;

FIG. 11 is a top perspective view of the constructed foldable sidewall body for use in the collapsible bulk bin container;

FIG. 12 is a top plan view of a blank B4 for making a foldable tray for the collapsible bulk bin container in accordance to a preferred embodiment of the present invention;

FIGS. 13A-13D illustrates the folding sequences of the blank B4 shown in FIG. 12 for constructing the foldable tray in accordance to the present invention;

FIG. 14 is a top perspective view of the constructed foldable tray for use in the collapsible bulk bin container;

FIG. 15 illustrates the manner in which foldable sidewall body is attached to the foldable tray;

FIG. 16 is an exploded perspective view of the lid, foldable sidewall body, and foldable tray in accordance to a preferred embodiment of the present invention;

FIG. 17 is a top perspective view of the collapsible bulk bin container that can be shipped in a knocked-down flattened condition as a single contained unit;

FIG. 18 is a top perspective view of a plurality of collapsible bulk bin containers stacked upon one another;

FIG. 19 is a top perspective view of a partially unfolded collapsible bulk bin container with the lid removed therefrom;

FIG. 20 is a top perspective view of the collapsible bulk bin container shown in FIG. 19 with partially filled up articles; and

FIG. 21 is a top perspective view of the collapsible bulk bin container shown in FIG. 21 with packed with articles and enclosed.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. In the present invention the use of prime character in the numeral references in the drawings directed to the different embodiment indicate that those elements are either the same or at least function the same.

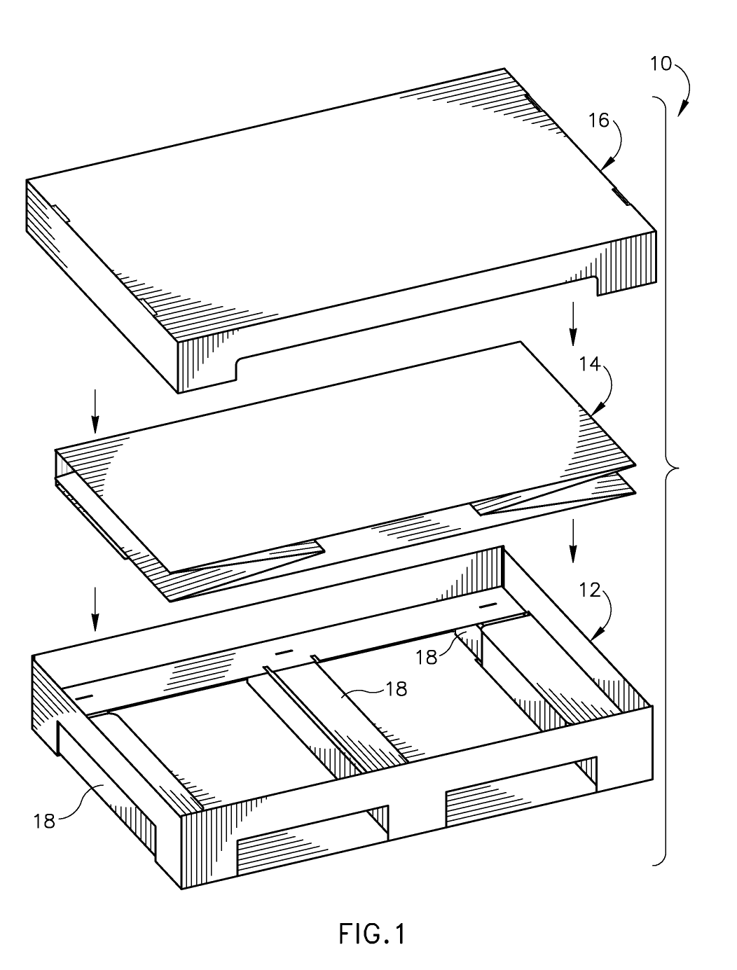

With reference to FIG. 1, a collapsible bulk bin container assembly 10 according to a preferred embodiment of the present invention includes a tray 12, a sidewall body 14, and a lid 16. A plurality of elongated pallet runners 18 are attached to the tray 12. The tray 12 including the elongated pallet runners 16, the sidewall body 14, and the lid 16 collectively defines a collapsible bulk bin container kit, which is sized sufficiently to contain articles therein for shipment and/or storage. The tray 12, sidewall body 14, and the pallet runners 18 are respectively sized so that the pallet runners 18 can support the weight of the articles shipped and/or stored therein. The sidewall body 14 and the pallet runners 18 may be adhered or otherwise affixed, either permanently or removably to the tray 12. For example, adhesives, glues, staples, nails, straps, or the like, may be used to couple sidewall body 14, and the pallet runners 16 to the tray 12 as will be described in greater detail below. The collapsible bulk bin container 10 is adapted to be stacked on one or more of the same collapsible bulk bin container 10.

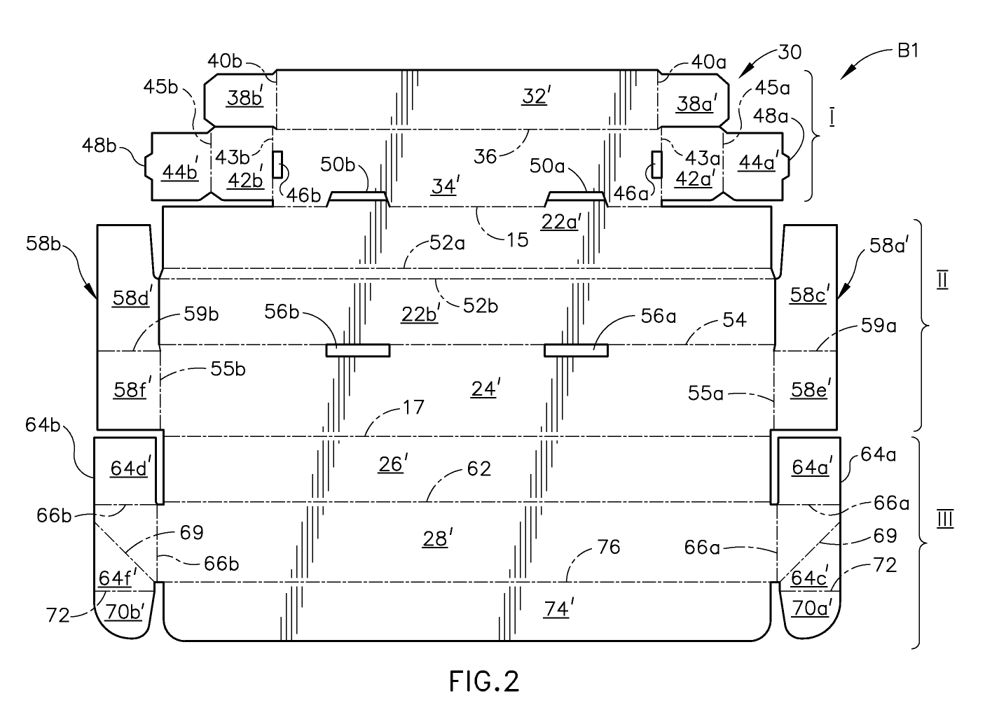

FIG. 2 is a top plan view of a blank B1 for making the pallet runner 18 for use in the collapsible bulk bin container 10 in accordance to a preferred embodiment of the present invention. The blank B1 is substantially flat symmetrical with respect to its lateral axis and preferably is an integral piece of a material such as continuous sheet of conventional corrugated paperboard. The blank B1 is cut along its outer margins to form its specific shape. The blank B1 is defined by three sections I, II, and III by two substantially parallel first and second fold lines 15 and 17, respectively. Section I forms an inner support structure 30 of the pallet runner 18 when the section I is in the folded position. Section II forms a first double side wall panels 22a′, 22b′ and a bottom wall panel 24′ of the pallet runner 18 when the section II is fully constructed. Section III forms a second side wall panel 26′ and a top wall panel 28′ when the section III is fully constructed.

The inner support structure 30 includes respective first and second panels 32′, 34′ defined by a third fold line 36. The first panels 32′ includes respective opposed first and second flaps 38a, 38b defined by respective fold lines 40a, and 40b and extend outwardly from respective lateral edges thereof. Respective third and fourth flaps 42a′, 42b′ foldably joined from respective lateral edges of the second panel 34′. The respective third and fourth flaps 42a′, 42b′ are defined by respective fold lines 43a, 45a and 43b, 44b. In addition, respective fifth and sixth flaps 44a, 44b is foldably joined to respective third and fourth flaps 42a′, 42b′. The respective fifth and sixth flaps 44a, 44b is defined by respective fold lines 45a, 45b. Respective first and second slots 46a, 46b are formed on the panel 34′ and each of which are located in proximity of the respective fold lines 43a, 43b. Each of the fifth and sixth flaps 44a, 44b includes respective first and second tabs 48a, 48b extends from respective free edges. The first and second locking tabs 48a, 48b are engaged with the corresponding first and second slots 46a, 46b when the first, second flaps 38a, 38b, third and fourth flaps 42a′, 42b′, fifth and sixth flaps 44a, 44b are in folding and overlapping relationship with one another. In addition, respective third and fourth locking tabs 50a, 50b are formed on longitudinal edge of the panel 34′ in proximity of the fold line 15. The third and fourth tabs 50a, 50b are spaced apart from one another and are engaged with respective third and fourth slots 56a, 56b when the inner support structure 20 is fully constructed. The inner support structure 30, when constructed, resembles a tray shape which is used as reinforcing and enhances the lateral strength of the pallet runner 18.

As noted above, section II forms a first double side wall panels 22a′, 22b′ and a bottom wall panel 24′ of the pallet runner 18 when the section II is fully constructed. The first double side wall panels 22a′, 22b′ are defined by two substantially parallel fold lines 52a, 52b and the bottom wall panel 24′ is defined by fold lines 54 and 17. The first double side wall panels 22a′, 22b′, when folded at right angle with respect parallel fold lines 52a, 52b, form a gap 78 between the side wall panels 22a′, 22b′so that section III can be foldably engaged with section II during construction of the pallet runner as will be described in greater detail herein below. The bottom wall 24′ includes first and second front roll minor flaps 58a, 58b that are foldably joined on the respective lateral edges thereof and are defined by fold lines 55a, 55b, respectively. Each of the first and second front rolls minor flaps 58a, 58b are foldably divided by a respective fold line 59a, 59b into first long flaps 58c, 58d and first short flaps 58e, 58f. The first long flaps 58c, 58d are engaged with the inner support structure 20 when they are in fully folded position and they are configured to be perpendicular to the respective first short flaps 58e, 58f. In this position, the short flaps 58e, 58f forms the end walls 60a, 60b of the pallet runner 18. Section III comprises of the second side wall panel 26′ and a top wall panel 28′ which is defined by fold line 62. The top wall 28′ includes first and second rear roll minor flaps 64a, 64b that are foldably joined on the respective lateral edges thereof and are defined by fold lines 66a, 66b, respectively. Each of the first and second rear rolls minor flaps 64a, 64b are foldably divided by a fold lines 66a, 66b into second long flaps 64c, 64d and second short flaps 64e, 64f. Each of the second long flaps 64c, 64d includes a respective locking tabs 70a, 70b defined by respective fold lines 72a, 72b. Fold lines 69 are formed on each of the second long flaps 64c, 64d to permit bending the second long flaps 64c, 64d during construction of the pallet runner 18. The top wall 28′ includes a tuck flap 74 define by a fold line 76.

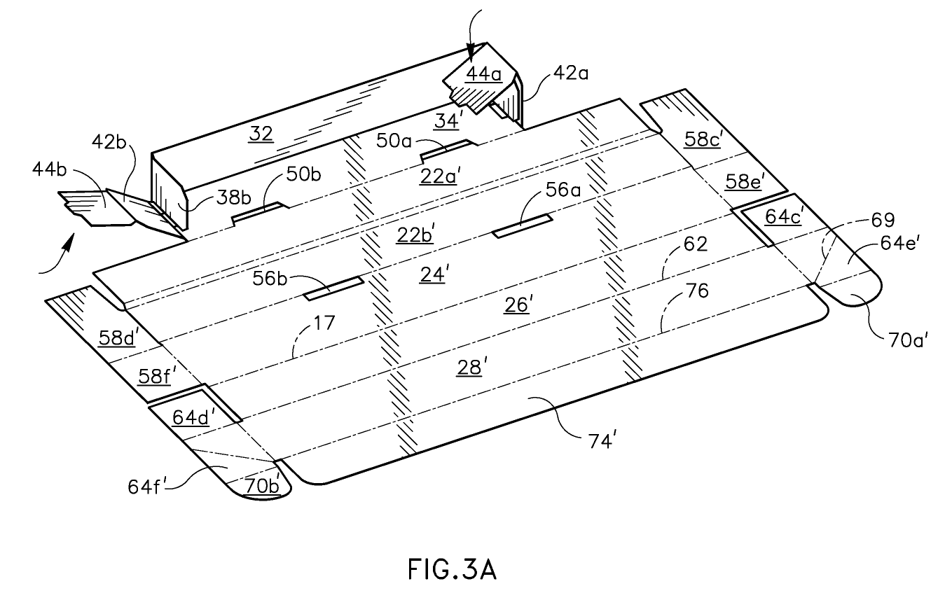

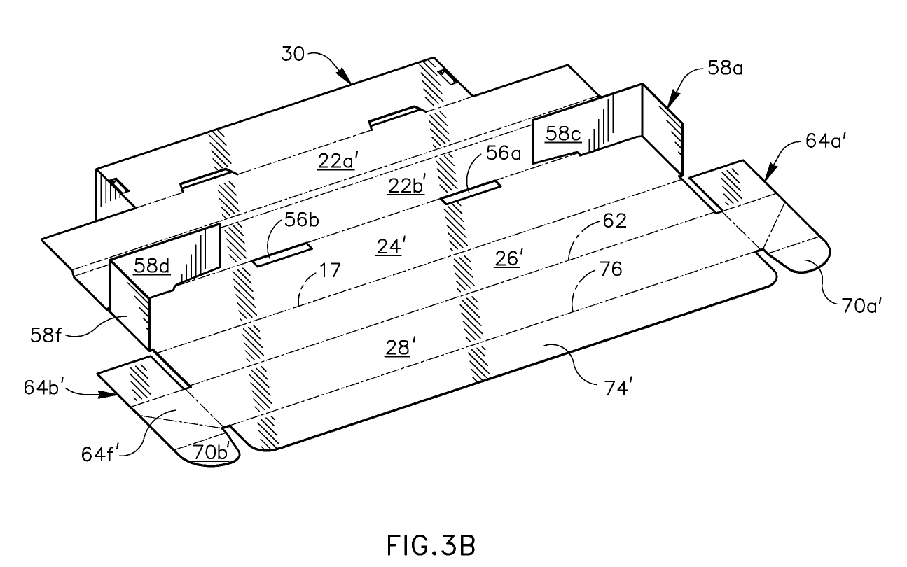

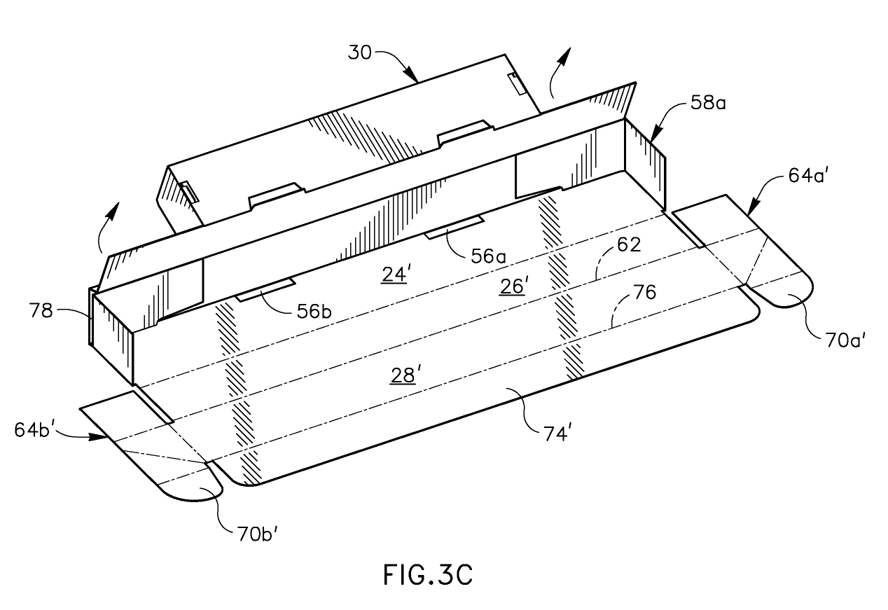

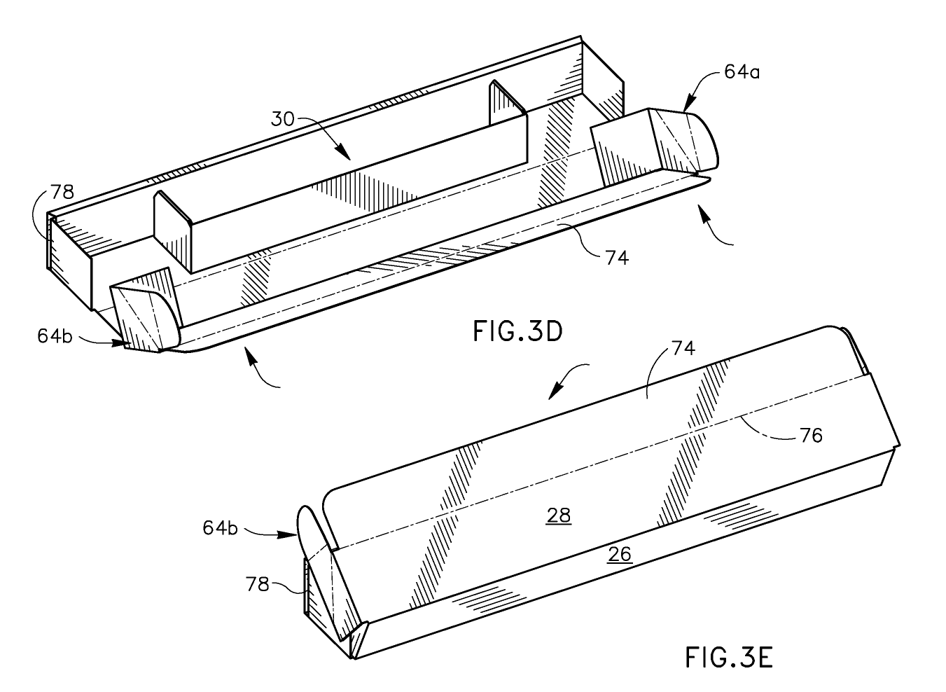

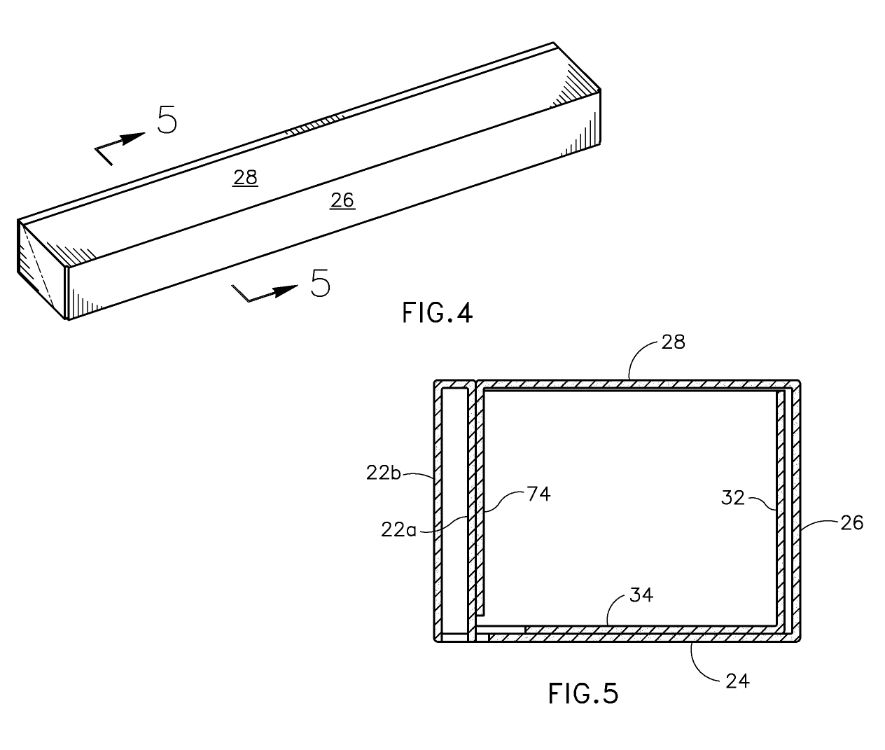

FIGS. 3A-3E illustrates folding sequences of the blank B1 shown in FIG. 2 for constructing the pallet runner 18. It should be noted that the proper size and configuration of these panels are important to construct sections I, II, and III that are brought into juxtaposition with one another to form the pallet runner 18 as fully constructed in FIG. 4.

Referring to FIGS. 3A-3E, manual set-up of the pallet runner 18 is easily accomplished. However, an ordinary skilled in the art would appreciate that a folding machine may alternatively perform the forming operations. In addition, depending on the size of the collapsible bulk bin container 10, any number of pallet runners 18 can be used, but in the preferred embodiment of the present invention, three pallet runners 18 are used. The blank B1 is laid horizontally with inside face down and in the first step of folding sequence the inner support structure 20 is constructed by folding the first panel 32′ up right with respect to panel 34′at the fold line 36 and simultaneously folding inwardly the first and second flaps 38a, 38b. Next, Respective third and fourth flaps 42a′, 42b′ and the respective fifth and sixth flaps 44a, 44b are folded onto one another in overlapping relationship with the first and second flaps 38a, 38b such that the first and second flaps 38a, 38b are tucked in between third and fourth flaps 42a′, 42b′ and the respective fifth and sixth flaps 44a, 44b and then the first and second locking tabs 48a, 48b are inserted to the corresponding first and second slots 46a, 46b. The blank B1 is now flipped over and the first and second front roll minor flaps 58a, 58b are folded as depicted in FIG. 3B. Next, the first double side wall panels 22a′, 22b′ are folded as depicted in FIGS. 3C and 3D in a manner that the first long flaps 58c′, 58d′ are disposed between the first double side wall panels 22a′, 22b′ and finally the inner support structure 20 folds over and the respective third and fourth tabs 50a, 50b are inserted to the respective third and fourth slots 56a, 56b. Next, the side wall 26′, the top wall 28′, and the respective first and second rear rolls minor flaps 64a, 64b are folded as illustrated in FIGS. 3D and 3E. Finally, the locking tabs 70a, 70b are inserted into gap 78 that is formed by the first double side wall panels 22a′, 22b′ to form the pallet runner 18. The locking tabs 70a, 70b completely enclose the respective opposed ends of the pallet runner 18. The cross section structure of pallet runner 18 as illustrated in FIG. 5 provide significant support for the plurality of articles contained in the collapsible bulk bin container 10.

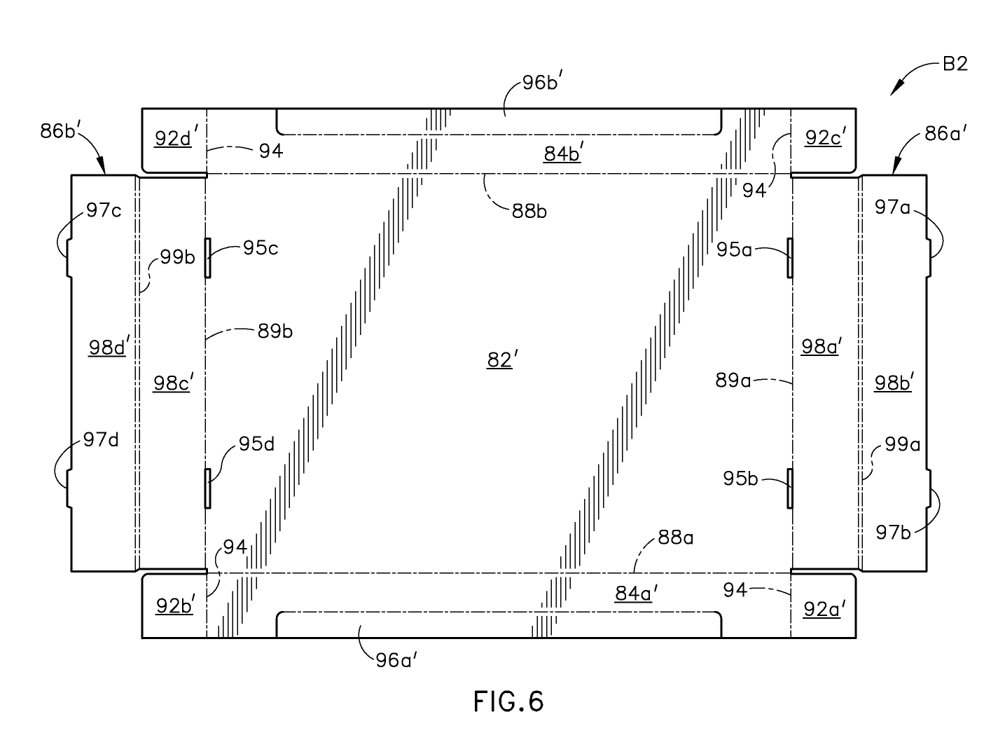

FIG. 6 is a top plan view of a blank B2 for making the lid 16 for the collapsible bulk bin container 10 in accordance to a preferred embodiment of the present invention. The blank B2 is preferably formed from a foldable corrugated paperboard, or the like, having generally planar and rectangular dimensions when in an unfolded, flat orientation. The blank B2 is divided by fold lines or score lines to define panels which are foldable relative to one another (as described in greater detail below) to form the lid portion 16 of the collapsible bulk bin container 10. The blank B2 is divided into a top wall panel 82′, first and second side wall panels 84a′, 84b′ and first and second end wall panels 86a′, 86b′ by a pair of longitudinal fold lines 88a, 88b and a pair of transverse fold lines 89a, 89b as shown in phantom lines. Each of the side wall panels 84a′, 84b′ includes a respective pair of lid flaps 92a′, 92b′, 92c′, 92d′ foldably extend from lateral edges and are defined by respective fold line 94. Furthermore, each of side wall panels 84a′, 84b′ also includes fork access panel 96a′, 96b′ which allows fork access when in the collapsed position. Each of the first and second end wall panels 86a′, 86b′ defines by a respective pair of end flaps 98a′, 98b′ and 98c′, 98d′ that folds over onto one another. For example, the end flap 98b′ folds over onto end flap 98a′ at the fold line 99a and the end flap 98d′ folds over onto end flap 98c′ at the fold line 99b. Each of the end flap 98b′ and 98d′ includes a pair of end wall tabs 97a, 97b and 97c, 97d at its respective free edges which are spaced apart from one another and are inserted into respective slots 95a, 95b and 95c, 95d when the blank B2 is fully constructed for making the lid 16.

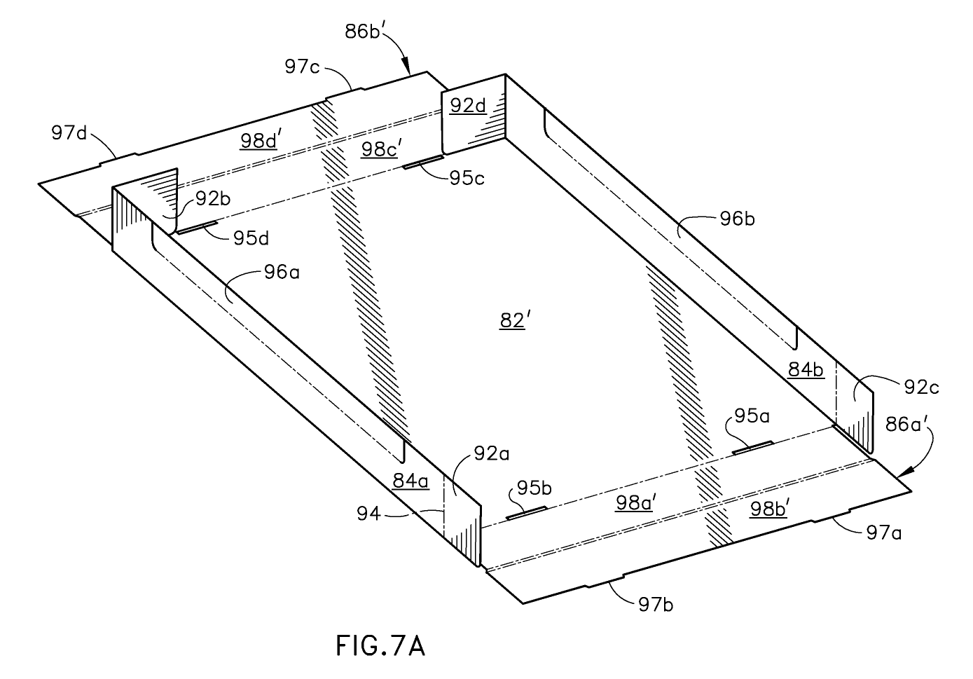

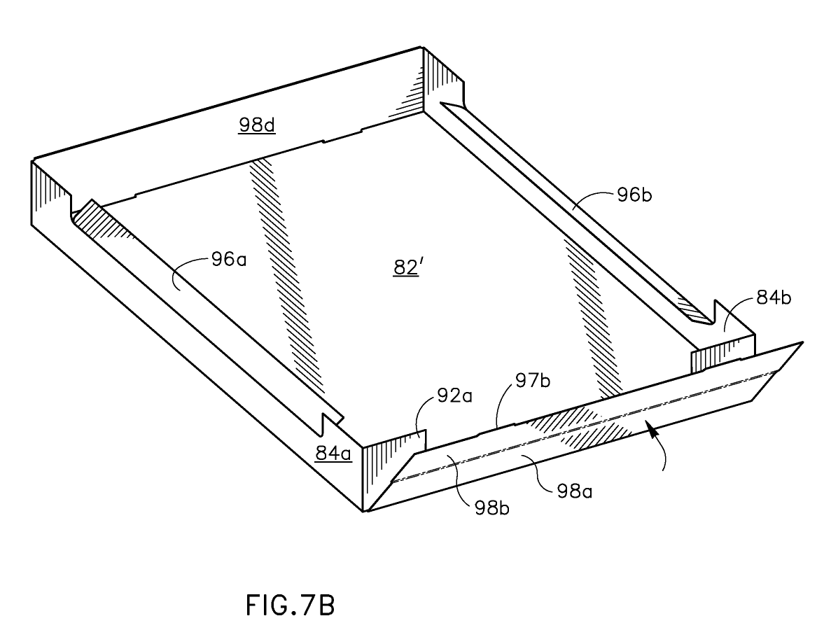

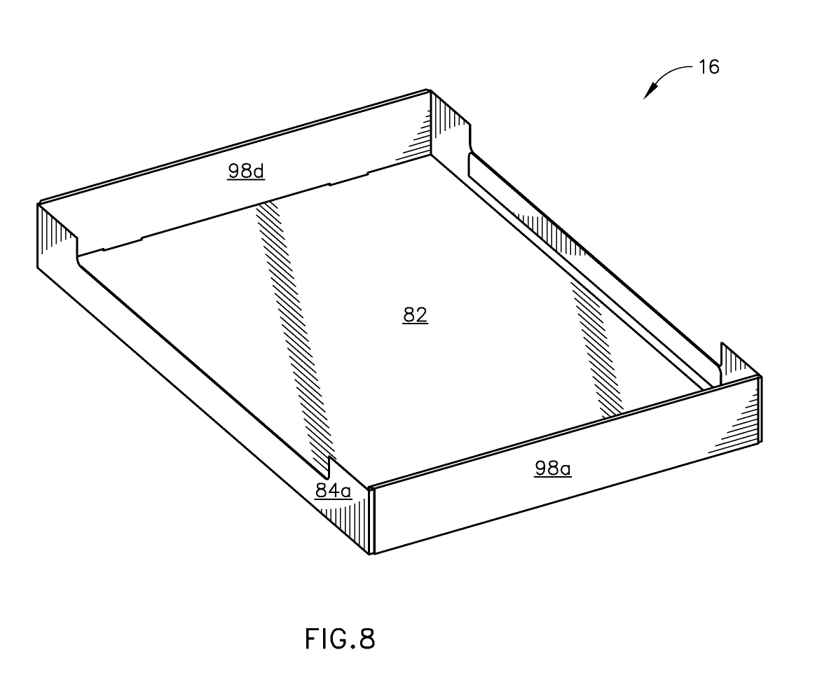

FIGS. 7A-7B illustrates the folding sequences of the blank B2 shown in FIG. 6 for constructing the lid 16 in accordance to the present invention. Although manual set-up of the lid 16 is easily accomplished, but an ordinary skilled in the art would appreciate that a folding machine may alternatively perform the forming operations. The blank B2 is laid horizontally and each of the side wall panels 84a′, 84b′ are folded upwardly to form a right angle with respect to the top wall panel 82′ and the a respective pair of lid flaps 92a′, 92b′, 92c′, 92d′ are folded toward one another to form a right angle with the respective side wall panels 84a′, 84b′. Next, each of the end flap 98b′, 98d′ is folded onto their respective end flaps 98a′, 98c′ along their respective fold lines 99a, 99b and the respective end wall tabs 97a, 97b and 97c, 97d are inserted into respective slots 95a, 95b and 95c, 95d. Finally, the fork access panel 96a′, 96b′ are folded as depicted in FIG. 7B to illustrate the top perspective view of the constructed lid 16 in FIG. 8 for use in the collapsible bulk bin container.

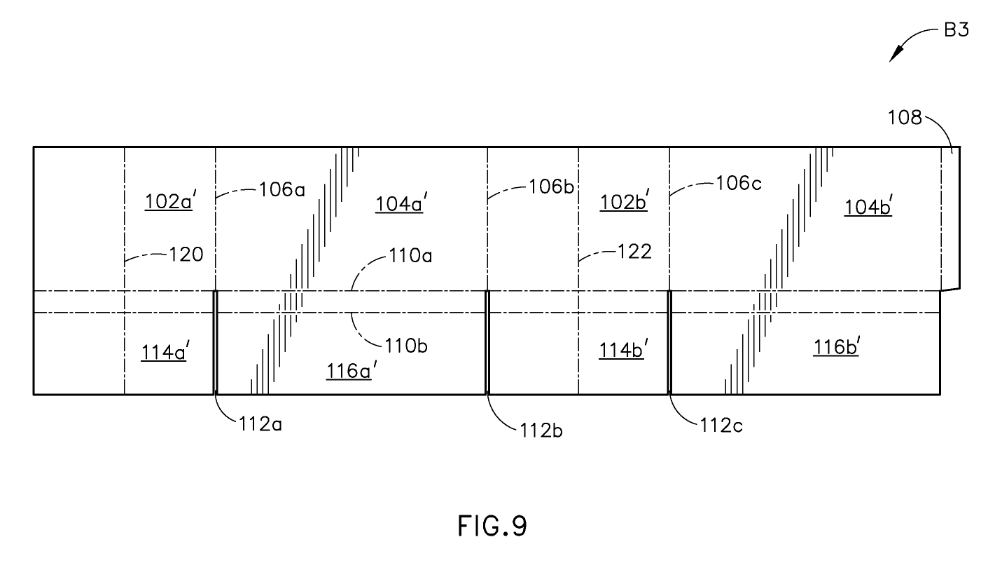

FIG. 9 is a top plan view of a blank B3 for making a foldable sidewall body 14 for use in the collapsible bulk bin container. The foldable sidewall body 14 is constructed from the blank B3 having preferably two end wall panels 102a, 102b and two side wall panels 104a, 104b defined by fold lines 106a, 106b, and 106c. A glue flap 108 is used to connect opposed ends of the blank B3 to one another in an end-to-end relation. In addition, flap-forming fold lines 110a, 110b extend the length of the blank B3 and cooperates with flap-forming slits 112a, 112b, 112c, to define side wall body flaps 114a, 114b, 116a, 116b, which cooperate with one another to define a closed bottom end 118 in a manner known generally to those of ordinary skilled in the art. Articulation folds 120, 122 are formed within the end wall panels 102a, 102b to facilitate both constructing the end wall panels 102a, 102b from the collapsed position and the collapse or folding of the end wall panels 102a, 102b from constructed position. Respective articulation folds 120, 122 bisect respective end wall panels 102a, 102b.

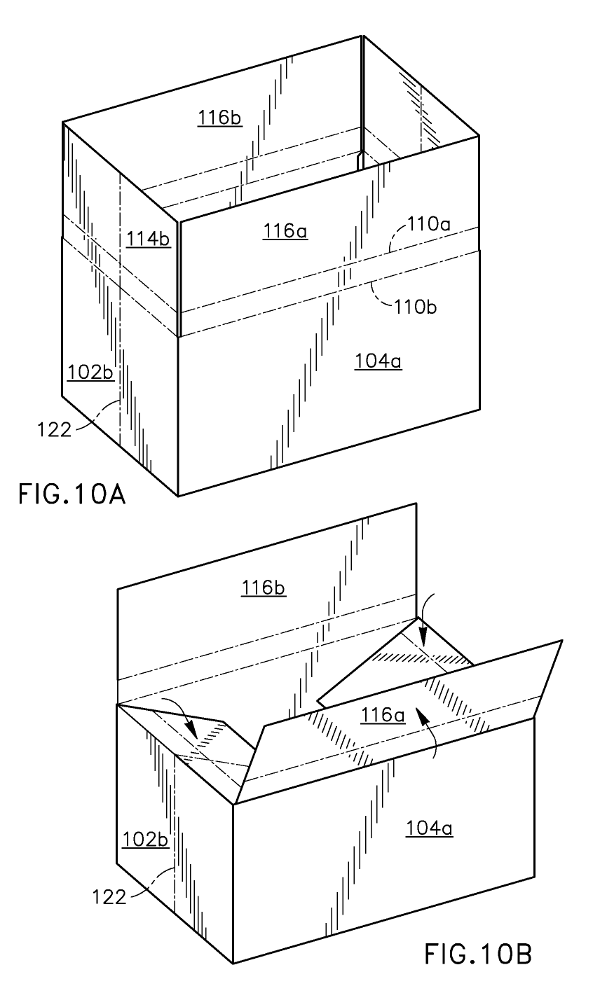

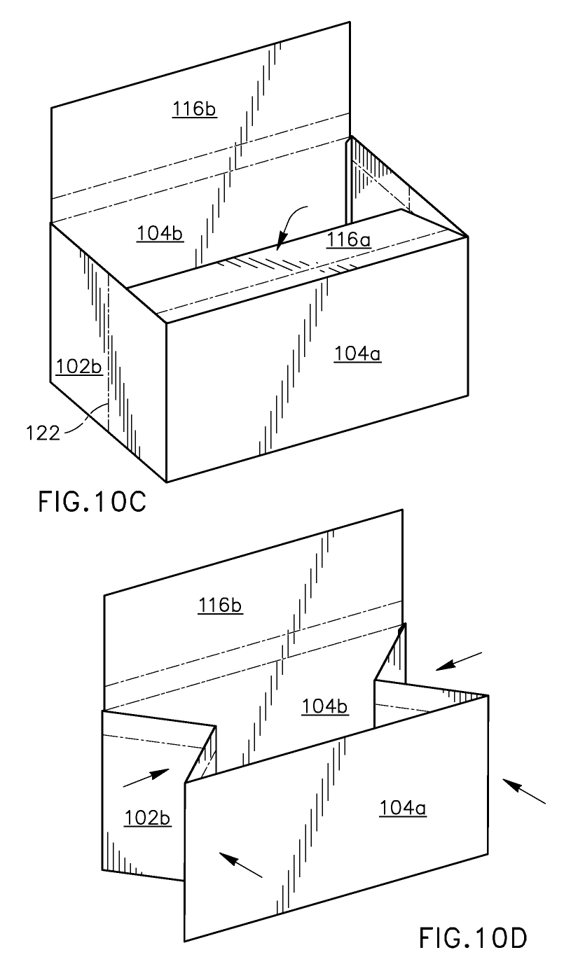

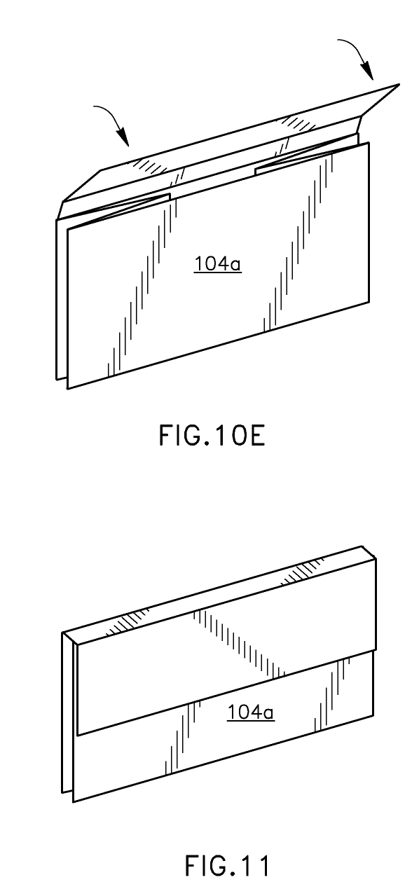

FIG. 10A-10E illustrates the folding sequences of the blank B3 shown in FIG. 9 for constructing the foldable sidewall body 14. Although manual set-up of the foldable sidewall body 14 is easily accomplished, but an ordinary skilled in the art would appreciate that a folding machine may alternatively perform the forming operations. The blank B3 is folded at the respective fold lines 106a, 106b, 106c and then the glue flap 108 is adhesively, but not limited to, attached to the edge of the end wall panel 102a as shown in FIG. 10A. Next, the end wall flaps 114a, 114b are folded inwardly toward the interior of the sidewall body 14 and similarly, the side wall body flap 116a is folded inwardly toward the interior of the sidewall body 14 as shown in FIGS. 10B, 10C. The side wall body flap 116b is designated as attachment flap 116b. Next, respective end wall panels 102a, 102b are pushed inwardly toward one another in a manner that the articulation folds 120, 122 move toward the interior of the sidewall body 14 to, in turn, facilitate the collapse of the end wall panels 102a, 102b as illustrated in FIGS. 10D, 10E. Finally, the attachment flap 116b is fold over the side wall panel 104a in an overlapping relationship. When the folding sequence is completed, the foldable sidewall body 14 resembles a briefcase as depicted in FIG. 11.

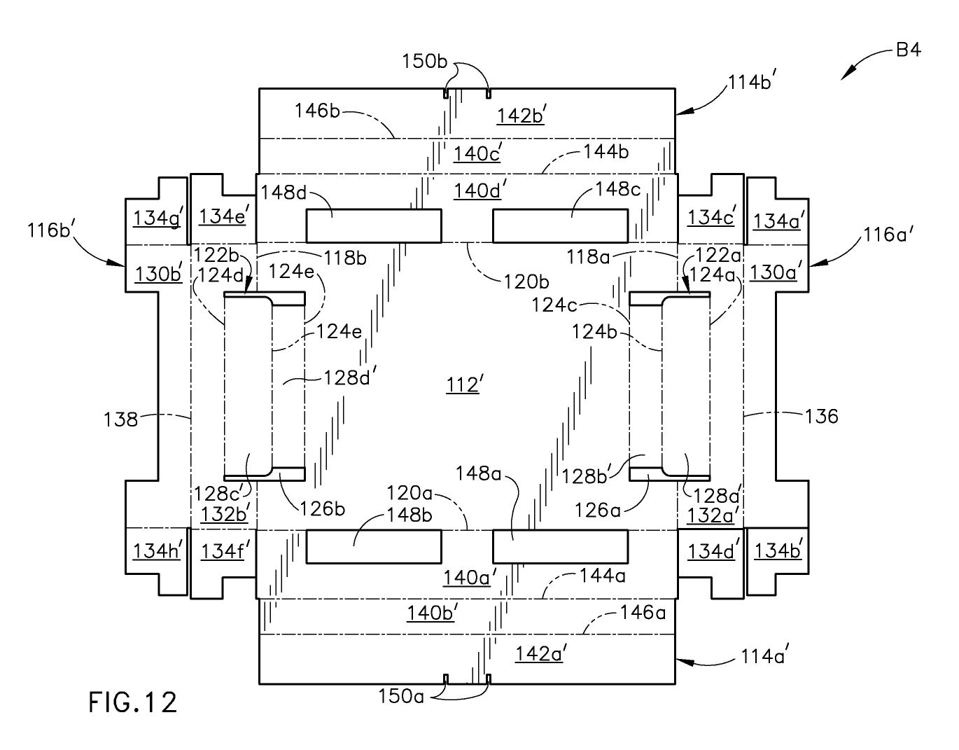

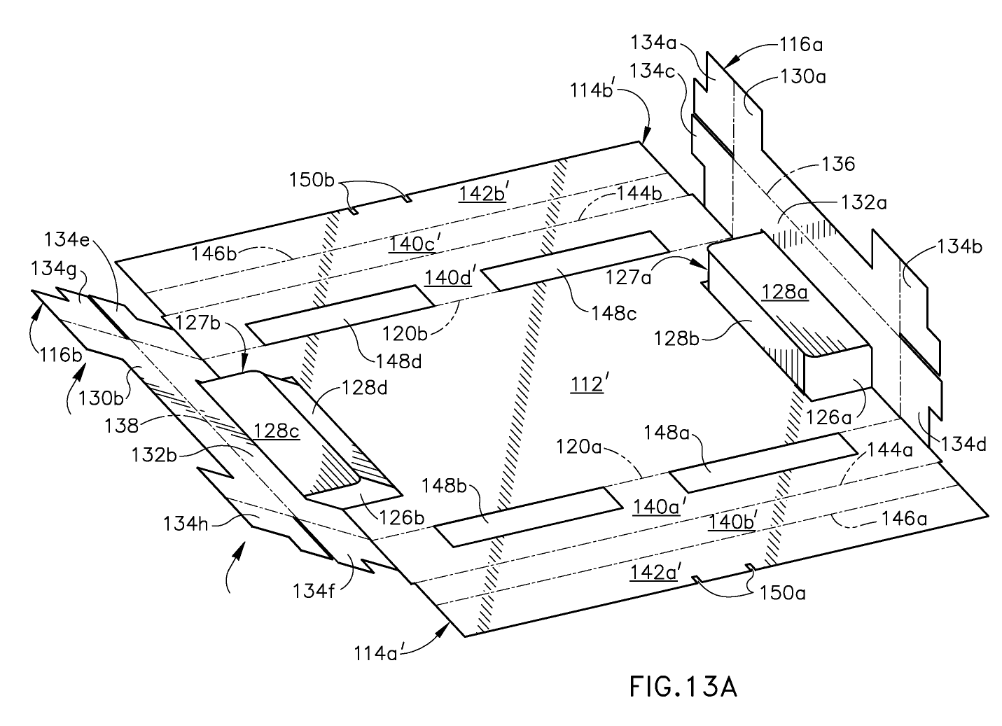

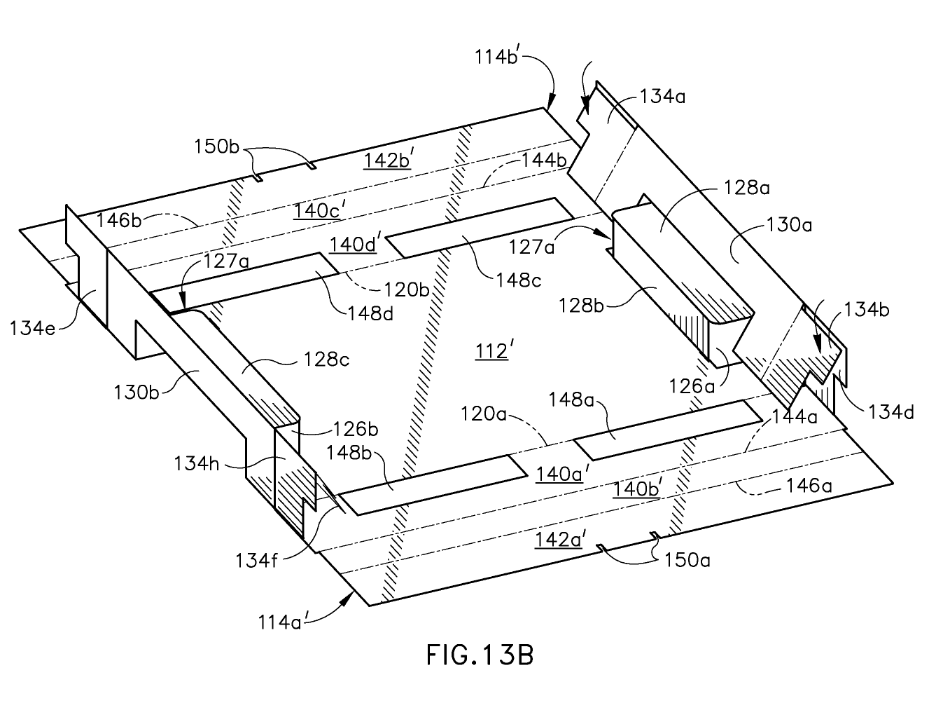

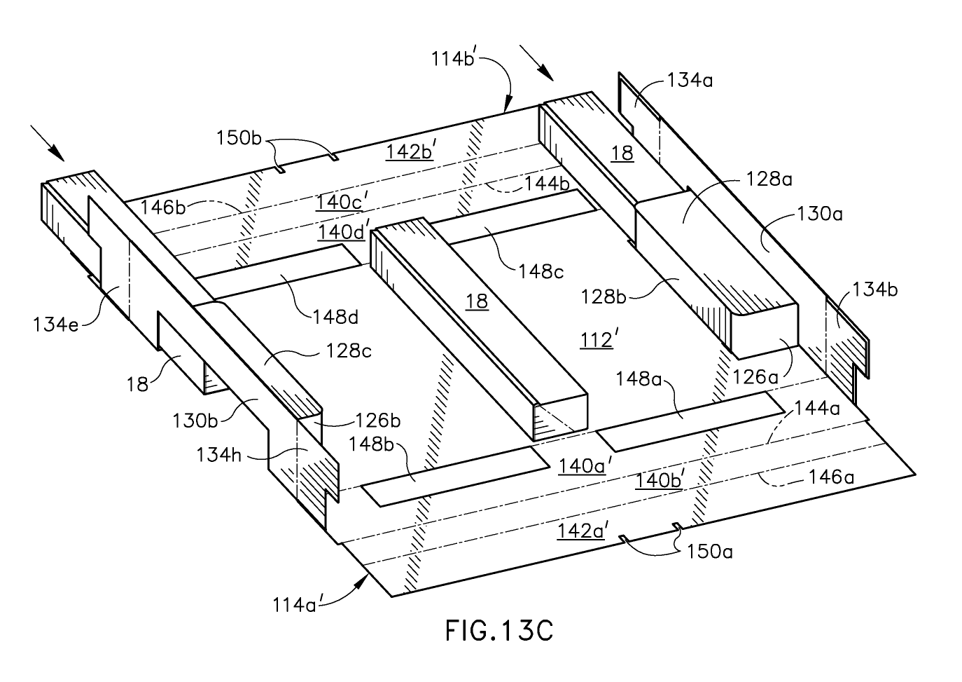

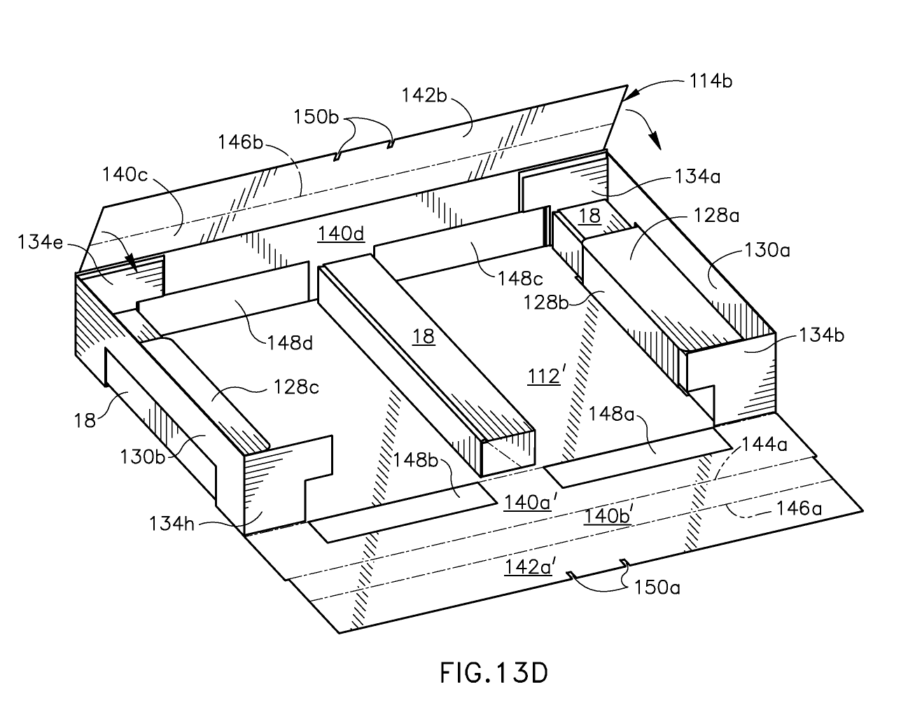

FIG. 12 is a top plan view of a blank B4 for making a foldable tray 12 for the collapsible bulk bin container 10 in accordance to a preferred embodiment of the present invention. The blank B4 is substantially flat symmetrical with respect to its lateral axis and preferably is an integral piece of a material such as continuous sheet of conventional corrugated cardboard. The blank B4 is cut along its outer margins to form its specific shape. The foldable tray blank B4 comprises a base wall panel 112′, two side wall panels 113a′, 113b′, and two end wall panels 117a′, 117b′ which are formed by two pairs of respective fold lines 118a, 118b, and 120a, 120b intersecting one another at right angles. Two pallet runner sleeves 122a and 122b are formed between the base wall panel 112′ and the two opposed end wall panels 117a′, 117b′. Each of the pallet runner sleeves 122a, 122b defined by respective three cut lines 124a, 124b, 124c and 124d, 124e, 124f and respective cutting away 126a, 126b of the base wall panel 112′ and two end wall panels 117a′, 117b′. Each of the pallet runner sleeves 122a, 122b has two surfaces 128a, 128b that are formed by their respective three cut lines 124a, 124b, 124c and 124d, 124e, 124f. Each of the respective pallet runner sleeves 122a, 122b resembles an elongated rectangular tube with two opposed open ended 127a, 127b when the foldable tray 110 is fully constructed as depicted in FIG. 13A. Each of the end wall panels 117a′, 117b′ includes respective inner and outer end panel 130a, 132b and 130b, 132b each of which having a respective pair of minor end flaps 134a, 134b; 134c, 134d; 134e, 134f; 134g, and 134h. The inner and outer end panel 130a, 132b and 130b, 132b are mirror image of one another and fold onto one another along respective fold lines 136 and 138 in an overlapping relationship.

Each of the side wall panels 113a′, 113b′ includes respective inner and outer panels 140a, 140b and 140c, 140d and respective shoulder panel 142a, 142b. The inner and outer panels 140a, 140b are defined by fold line 144a and the shoulder panel 142a is defined by fold line 146a. Similarly, the inner and outer panels 140c, 140d are defined by fold line 144b and the shoulder panel 142b is defined by fold line 146b. Each of the two side wall panels 113a′, 113b′ includes a respective pair of fork access entry 148a, 148b and 148c, 148d formed on respective outer panel 140a and 140d. The fork access entry 148a, 148b are generally rectangular in shape and spaced apart from one another. Each of the side wall panels 113a′, 113b′ includes respective alignment marks 150a, 150b that are used to properly position and align when the pallet runner 18 is attached to the foldable tray 12.

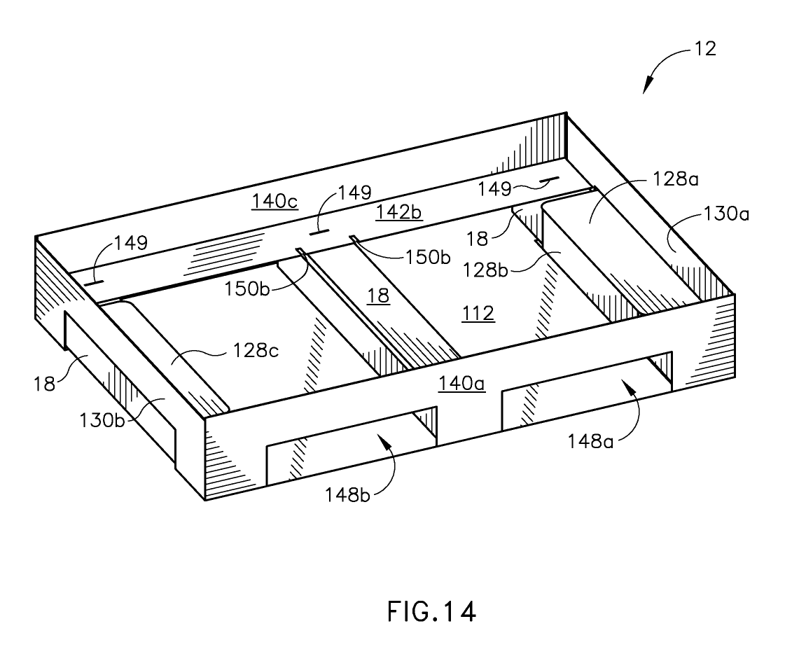

FIG. 13A-13D illustrates the folding sequences of the blank B4 shown in FIG. 12 for constructing the foldable tray 12 in accordance to the present invention. Although manual set-up of the foldable tray 12 is easily accomplished, but one of the ordinary skilled in the art would appreciate that a folding machine may alternatively perform the forming operations. In the first step of folding sequence, each of the end wall panels 117a′, 117b′ are folded upright along respective fold line 118a, 118b which, in turn, cause each of the pallet runner sleeves 122a, 122b to be unfolded so that the open ended 127a, 127b are formed, accordingly. Next, each of the respective inner end panel 130a, 130b is folded onto the respective outer end panel 132a, 132b in an overlapping relationship as depicted in FIG. 13B. Next, the pallet runners 18 are inserted into the respective openings 127a, 127b of the respective sleeves 122a, 122b as illustrated in FIG. 13C. Particularly referring to FIGS. 13C, 13D, one of the pallet runners 18 is disposed in the central portion of the base wall panel 112′ and aligned with the alignment marks 150a, 150b. Next, each of the respective side wall panels 113a′, 113b′ fold upright so that respective inner and outer panels 140a, 140b folds onto one another and respective inner and outer panels 140c, 140d fold onto one another and the respective shoulder panels 142a, 142b are stapled 149 or otherwise affixed to the foldable tray 12 as depicted in FIG. 14.

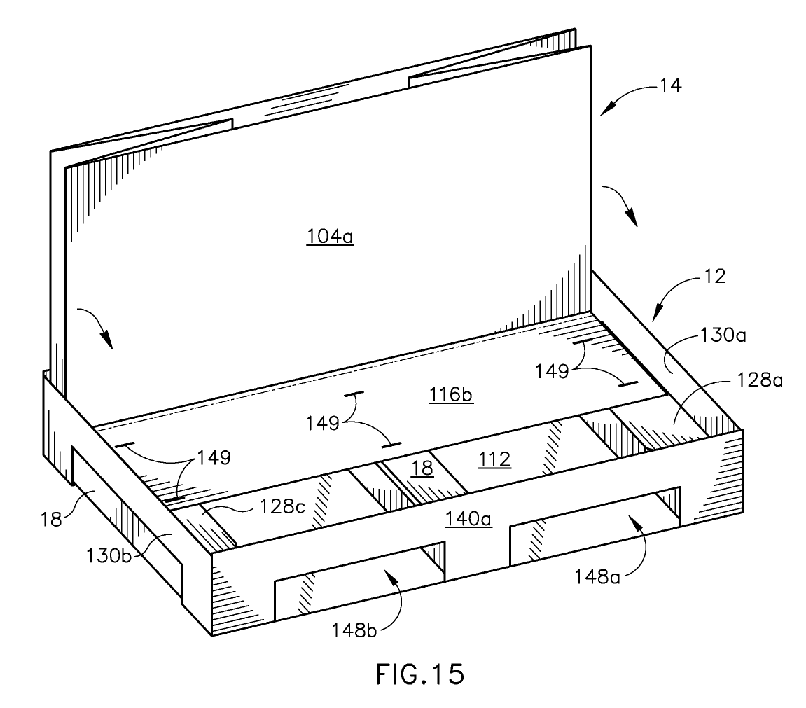

FIG. 15 illustrates the manner in which foldable sidewall body 14 is attached to the foldable tray 12. To do that, the side wall body attachment flap 116b is laid horizontally in a manner that is co-planner with respect to the foldable tray 12 and is stapled 149 or otherwise affixed to the foldable tray 12 in the locations as depicted in FIG. 15. Next, the two folded end wall panels 102a, 102b and the two folded side wall panels 104a, 104b of the sidewall body 14 are laid down in a position substantially co-planar with respect to the foldable tray 12.

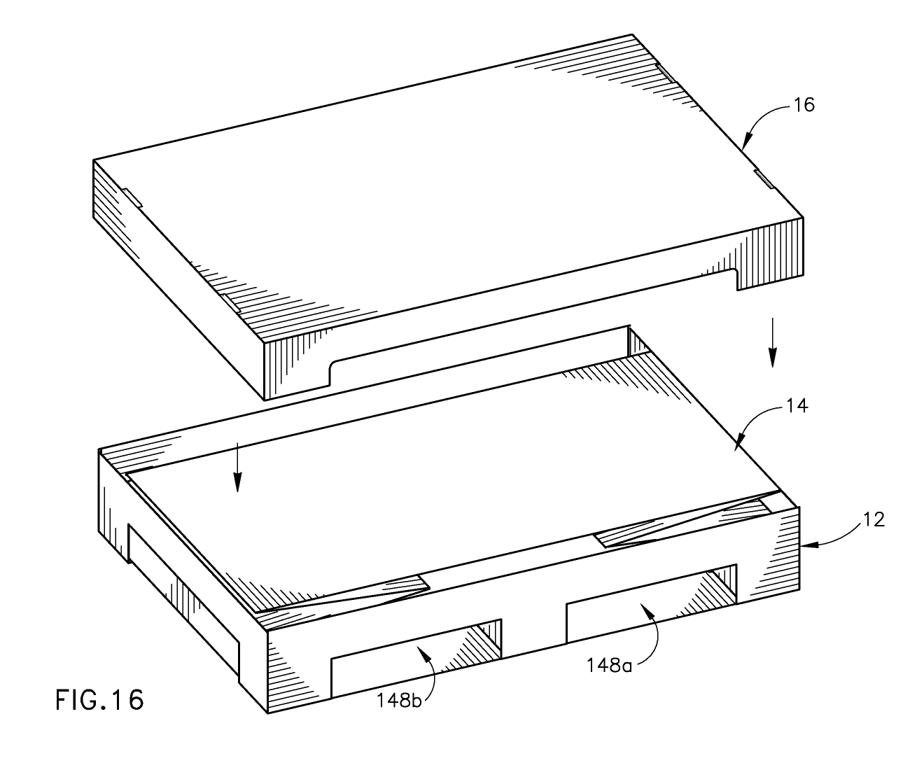

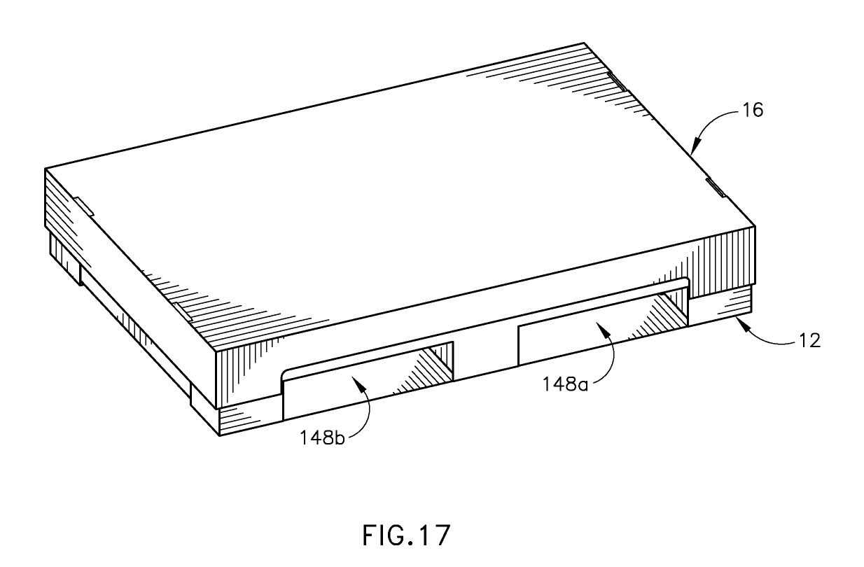

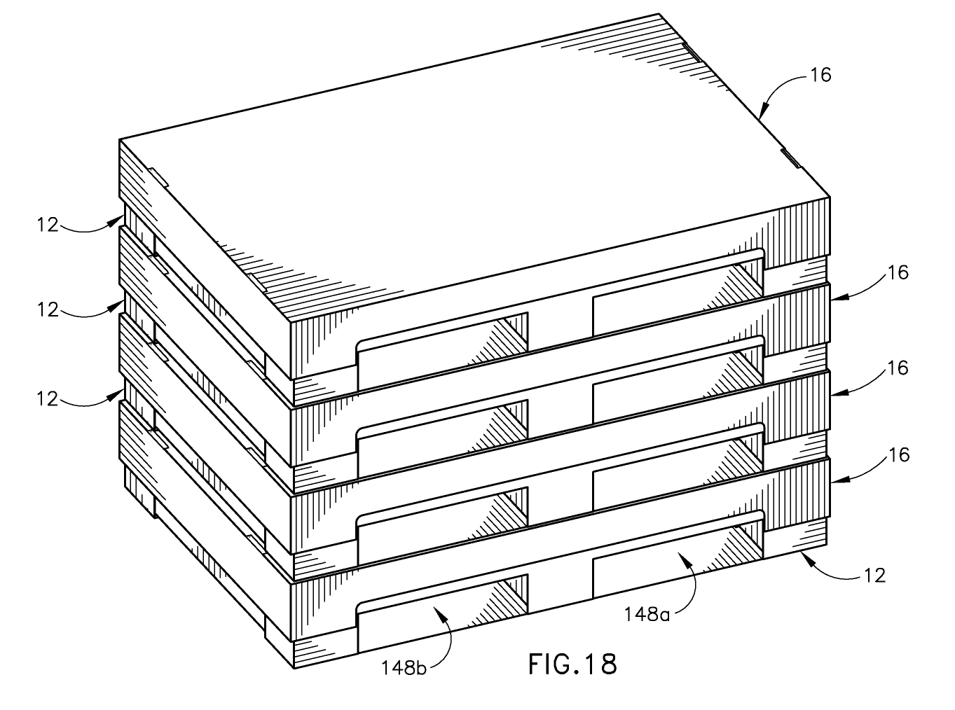

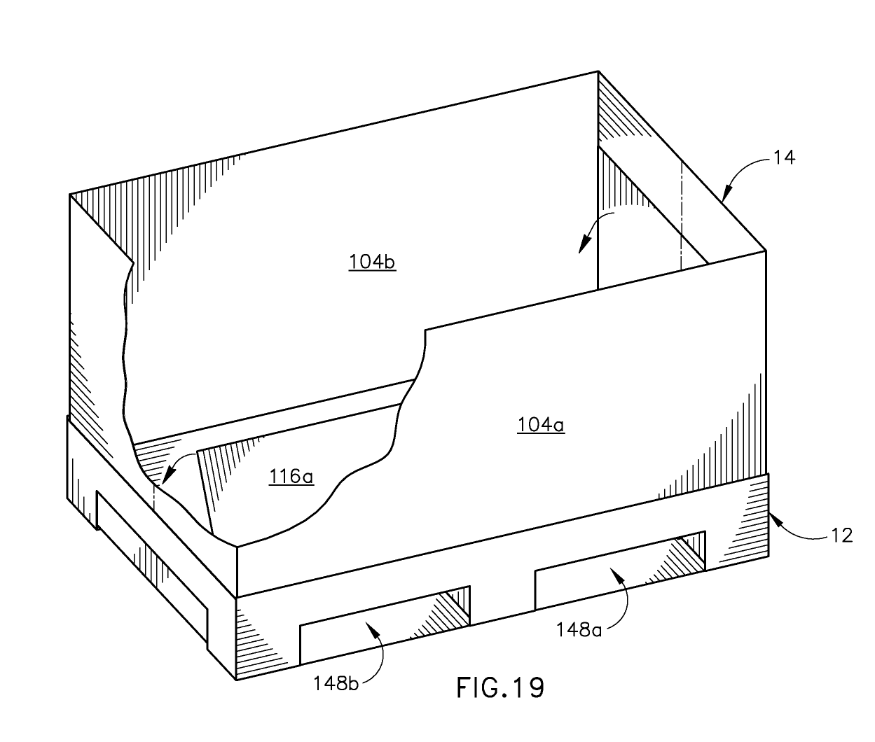

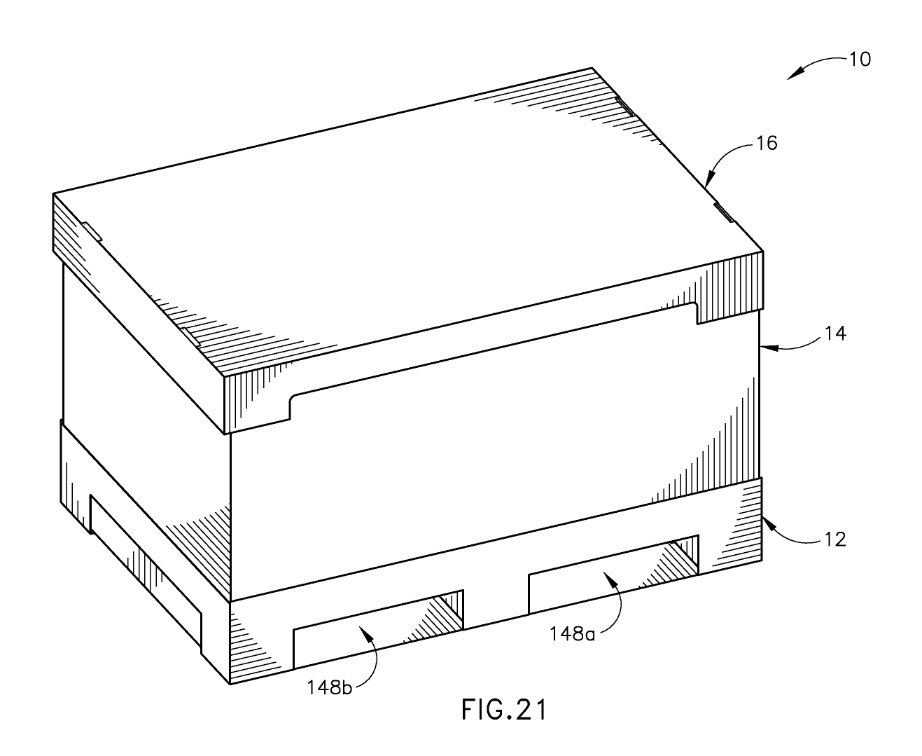

Illustrated in FIG. 16 is the foldable sidewall body 14 is fully collapsed inside foldable tray 12 with the lid 16 positioned in an exploded perspective view. It should be noted that the foldable sidewall body 14 sits inside the peripheral boundaries of the foldable tray having a minimum profile. The lid 16 is positioned over the foldable tray 12 so as to completely enclose the collapsed bulk bin container 10 for storage and transportation to an end user as depicted in FIG. 17. The lid 16 is also used to cap the collapsible bulk bin container 10 when in its fully constructed position of FIG. 21 so as to be capable of protecting the articles container in the collapsible bulk bin container 10. The fork access entry 148a, 148b are provided to accommodate the tines of a forklift during transportation of the collapsible bulk bin container 10. To significantly reduce the space and cost in transporting the collapsed bulk bin container 10, the containers may be stacked on one another as shown in FIG. 18.

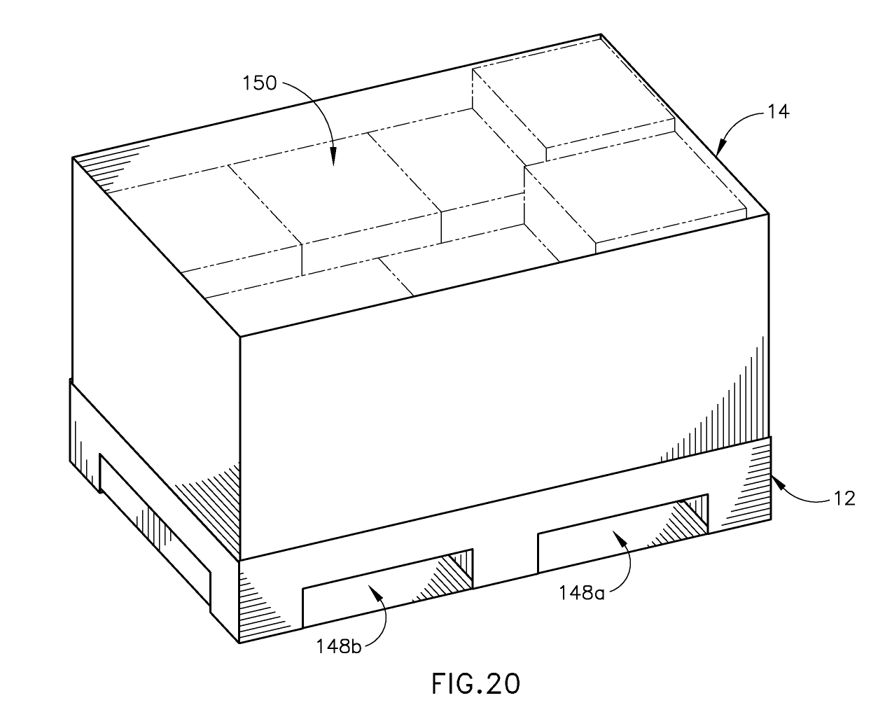

To erect the collapsed bulk bin container 10, the lid 16 is removed and then foldable sidewall body 14 expands by moving the side wall panel 104a away from the foldable tray 12 and pivoting the side wall body flap 116a toward the attachment flap 116b so that the side wall body flap 116a and the attachment flap 116b are aligned with one another to form the bottom of the foldable sidewall body 14 and thereby initiating the articulation folds 120, 122 moving away from the interior of the sidewall body 14 and each other as depicted in FIG. 19. When the collapsed bulk bin container 10 is fully erected, the two side wall panels 104a, 104b are vertically orientated so as to be substantially perpendicular to the pallet runners 18 and the two end wall panels 102a, 102b being perpendicular to the two side wall panels 104a, 104b to form a rectangular shaped container. It is contemplated that the side wall body flap 116a would maintain its respective position by the weight of the article disposed in the interior foldable sidewall body 14 or otherwise, could be maintained by various locking mechanism. The collapsible bulk bin container 10 may now be filled up by variety of articles 150 by a user as shown in FIG. 20 and completely enclose collapsible bulk bin container 10 by the lid 16 as depicted in FIG. 21.

The collapsible bulk bin container 10 assembly of the present invention avoids the drawbacks of prior art knock down containers, including general structural weakness, loose fitting top cover and bulkiness of shipping. The inventive collapsible bulk bin container 10 assembly has a small footprint when transported or stored empty and folds up or can be assembled rapidly without the use of tools. The knock down bulk bin can be stacked and stored efficiently when in the knocked-down position. When in the knocked-down position, the collapsible bulk bin container 10 provides a convenient and efficient returnable package for customers and is completely recyclable at the end of its effective use cycle. Unlike wooden pallets, the inventive collapsible bulk bin container 10 can be shipped internationally without having to meet lumber treatment standards.

Accordingly, one aspect of the present invention is directed to a collapsible container comprising a foldable tray having a plurality of pallet runner sleeves. A plurality of elongated pallet runners each of which is adapted to be removably inserted into each of the respective plurality of pallet runner sleeves. A foldable side wall body is adapted to rest upon the foldable tray to form an interior space to receive a plurality of articles. A lid is telescopically enclosing the collapsible container. The foldable tray comprises a plurality of fork access openings formed therein to accommodate the tines of a forklift. The plurality of fork access openings are in both opposed side walls of the foldable tray for a two-way entry of the tines of a forklift. The plurality of pallet runner sleeves includes two pallet runner sleeves spaced apart from one another and are integrally formed on respective opposed lateral edges of the foldable tray. Each of the plurality of elongated pallet runners includes an inner support structure integrally formed thereto to enhance lateral strength of each of the plurality of elongated pallet runners. The plurality of elongated pallet runners includes three pallet runners wherein two of which are inserted to the respective plurality of pallet runner sleeves and one of the three pallet runners is disposed in proximity of center of the foldable tray. Both opposed ends of each of the plurality of elongated pallet runners are enclosed. The foldable side wall body comprises end walls, side walls, and side body flaps to form an enclosed bottom thereof and wherein each of the end walls includes an articulation fold formed therein to bisect the respective end wall panels. The foldable side wall body is attached to the foldable tray via an attachment flap. The foldable sidewall body sits inside peripheral boundaries of the foldable tray having a minimum profile. The foldable tray, the plurality of elongated pallet runners, and the foldable side wall body are all formed from corrugated paperboard material.

Another aspect of the present invention is directed to a collapsible shipping container is capable of configured from a collapsed position for storage and transportation to a constructed position for containment of articles therein and back again to the collapsed position after use. The collapsible shipping container comprises a foldable tray having at least two pallet runner sleeves spaced apart from one another and each of which being formed on respective opposed lateral edges of the foldable tray. A plurality of elongated pallet runners each of which having an inner support structure integrally formed thereto. The plurality of elongated pallet runners each of which is adapted to be inserted into each of the respective plurality of pallet runner sleeves. A foldable side wall body is adapted to rest upon the foldable tray to form an interior space to receive a plurality of articles. The foldable side wall body comprises end walls, side walls, and side body flaps to form an enclosed bottom thereof. Each of the end walls includes an articulation fold formed therein so that during the collapsed position, the articulation folds move toward the interior space and during the constructed position, the articulation folds move away from the interior space. A lid is configured to telescopically enclosing the collapsible shipping container.

One further aspect of the present invention is directed to a method for constructing a collapsible shipping container. The method comprising the steps of forming a foldable tray made from a blank B4. The foldable tray has a base wall panel, two side wall panels, and two end wall panels which are formed by two pairs of respective fold lines intersecting one another at right angles. Two pallet runner sleeves are formed between the base wall panel and the two opposed end wall panels. Then, forming a plurality of elongated pallet runners each of which made from a blank B1, the plurality of elongated pallet runners being affixed to the foldable tray, the plurality of elongated pallet runners includes an inner support structure integrally formed thereto and forming a foldable side wall body made from a blank B3, the foldable side wall body configured to be attached to the foldable tray to form an interior space to receive a plurality of articles wherein the foldable side wall body comprises two end walls, two side walls, and side body flaps to form an enclosed bottom thereof wherein each of the end walls includes an articulation fold formed therein so that during the collapsed position, the articulation folds move toward the interior space and during the constructed position, the articulation folds move away from the interior space.

While the invention has been described and illustrated with reference to one or more preferred embodiments thereof, it is not the intention of the Applicants that the invention be restricted to such detail. Rather, it is the intention of the Applicants that the invention be defined by all equivalents, both suggested hereby and known to those of ordinary skill in the art, of the preferred embodiments.

What is claimed is:

1. A collapsible container comprising:
a foldable tray having a plurality of pallet runner sleeves;
a plurality of elongated pallet runners each of which being adapted to be removably inserted into each of the respective plurality of pallet runner sleeves; and
a foldable side wall body being adapted to rest upon the foldable tray to form an interior space to receive a plurality of articles.

2. The collapsible container of claim 1 further comprising a lid telescopically enclosing the collapsible container.

3. The collapsible container of claim 1 wherein the foldable tray comprises a plurality of fork access openings formed therein to accommodate the tines of a forklift.

4. The collapsible container of claim 3 wherein the plurality of fork access openings are in both opposed side walls of the foldable tray for a two-way entry of the tines of a forklift.

5. The collapsible container of claim 1 wherein the plurality of pallet runner sleeves includes two pallet runner sleeves spaced apart from one another and are integrally formed on respective opposed lateral edges of the foldable tray.

6. The collapsible container of claim 1 wherein each of the plurality of elongated pallet runners includes an inner support structure integrally formed thereto to enhance lateral strength of each of the plurality of elongated pallet runners.

7. The collapsible container of claim 1 wherein the plurality of elongated pallet runners includes three pallet runners wherein two of which are inserted to the respective plurality of pallet runner sleeves and one of the three pallet runners is disposed in proximity of center of the foldable tray.

8. The collapsible container of claim 1 wherein both opposed ends of each of the plurality of elongated pallet runners are enclosed.

9. The collapsible container of claim 1 wherein the foldable side wall body comprises end walls, side walls, and side body flaps to form an enclosed bottom thereof and wherein each of the end walls includes an articulation fold formed therein to bisect the respective end wall panels.

10. The collapsible container of claim 1 wherein the foldable side wall body is attached to the foldable tray via an attachment flap.

11. The collapsible container of claim 1 wherein the foldable sidewall body sits inside peripheral boundaries of the foldable tray having a minimum profile.

12. The collapsible container of claim 1 wherein the foldable tray, the plurality of elongated pallet runners, and the foldable side wall body are all formed from corrugated paperboard material.

13. A collapsible shipping container being capable of configured from a collapsed position for storage and transportation to a constructed position for containment of articles therein and back again to the collapsed position after use, the collapsible shipping container comprising:
a foldable tray having at least two pallet runner sleeves spaced apart from one another and each of which being formed on respective opposed lateral edges of the foldable tray;
a plurality of elongated pallet runners each of which having an inner support structure integrally formed thereto, the plurality of elongated pallet runners adapted to be inserted into each of the respective plurality of pallet runner sleeves;
a foldable side wall body being adapted to rest upon the foldable tray to form an interior space to receive a plurality of articles and wherein the foldable side wall body comprises end walls, side walls, and side body flaps to form an enclosed bottom thereof wherein each of the end walls includes an articulation fold formed therein so that during the collapsed position, the articulation folds move toward the interior space and during the constructed position, the articulation folds move away from the interior space; and
a lid configured to telescopically enclosing the collapsible shipping container.

14. The collapsible shipping container of claim 13 is made from corrugated paperboard material.

15. A method for constructing a collapsible shipping container, the method comprising the steps of:
forming a foldable tray made from a blank B4, the foldable tray having a base wall panel, two side wall panels, and two end wall panels which are formed by two pairs of respective fold lines intersecting one another at right angles and two pallet runner sleeves being formed between the base wall panel and the two opposed end wall panels;
forming a plurality of elongated pallet runners each of which made from a blank B1, the plurality of elongated pallet runners being affixed to the foldable tray, the plurality of elongated pallet runners includes an inner support structure integrally formed thereto; and
forming a foldable side wall body made from a blank B3, the foldable side wall body configured to be attached to the foldable tray to form an interior space to receive a plurality of articles wherein the foldable side wall body comprises two end walls, two side walls, and side body flaps to form an enclosed bottom thereof wherein each of the end walls includes an articulation fold formed therein so that during the collapsed position, the articulation folds move toward the interior space and during the constructed position, the articulation folds move away from the interior space.

16. The method of claim 15 further comprising of forming a lid made from a blank B2 configured to telescopically enclosing the collapsible shipping container.
